(19) United States
(12) Patent Application Publication
(10) Pub. No.: US 2013/0339784 A1
(43) Pub. Date: Dec. 19, 2013

(54) ERROR RECOVERY IN REDUNDANT STORAGE SYSTEMS

(71) Applicants: Craig A. Bickelman, Connelly, NY (US); Brian Bowles, Rochester, MN (US); David D. Cadigan, Brewster, NY (US); Edward W. Chencinski, Poughkeepsie, NY (US); Robert E. Galbraith, Rochester, MN (US); Adam J. McPadden, Underhill, VT (US); Kenneth J. Oakes, Wappingers Falls, NY (US); Peter K. Szwed, Rhinebeck, NY (US)

(72) Inventors: Craig A. Bickelman, Connelly, NY (US); Brian Bowles, Rochester, MN (US); David D. Cadigan, Brewster, NY (US); Edward W. Chencinski, Poughkeepsie, NY (US); Robert E. Galbraith, Rochester, MN (US); Adam J. McPadden, Underhill, VT (US); Kenneth J. Oakes, Wappingers Falls, NY (US); Peter K. Szwed, Rhinebeck, NY (US)

(73) Assignee: INTERNATIONAL BUSINESS MACHINES CORPORATION, Armonk, NY (US)

(21) Appl. No.: 13/524,719

(22) Filed: Jun. 15, 2012

(51) Int. Cl. G06F 11/14

(52) U.S. Cl. 714/6.11; 714/E11.118

(57) ABSTRACT

Embodiments relate to providing error recovery in a storage system that utilizes data redundancy. An aspect of the invention includes monitoring plurality of storage devices of the storage system and determining that one of the plurality of storage devices has failed based on the monitoring. Another aspect of includes suspending data reads and writes to the failed storage device and determining that the failed storage device is recoverable. Based on determining that the failed storage device is recoverable, initiating a rebuilding recovery process of the failed storage device based on determining that the failed storage device is recoverable and restoring data reads and writes to the failed storage device upon completion of the rebuilding recovery process.

### BACKGROUND

The present invention relates generally to error recovery in redundant storage systems, and more specifically, to error recovery in redundant arrays of independent disks (RAID) systems.

Enterprise class computing systems and storage devices employ sophisticated storage systems to protect the integrity of data stored on direct access storage device (DASD) drives. Storage systems, such as RAID systems, are controlled by complex hardware and firmware which attempts to provide full protection and responsiveness during the life of the devices. In many systems, a technique known as mirroring is employed to provide a very high state of fault tolerance, by building two fully duplicate copies of the stored data in physically separate devices. When one of these physical devices fails, the data can always be procured from the mirrored copy in the independent device.

Currently a variety of algorithms are used to manage RAID systems. For example, RAID-0 provides for block-level striping without parity or mirroring, but it has no redundancy. In contrast, RAID-1 provides mirroring without parity or striping, data is written identically to two drives. RAID-10 is a combination of RAID-1 and RAID-0 that includes mirrored sets in a striped set and provides fault tolerance and improved performance but increases complexity.

Occasionally, a DASD device failure may occur which causes the storage controller to discontinue using the device in a RAID array, thus allowing the RAID array to continue functioning but with reduced redundancy. During this process, referred to as ‘exposing the array’, the storage controller insures that the failing device will not impact the responsiveness of the RAID system and will not compromise data integrity. However, some device failures which are detected as the device taking too long to perform an I/O operation or detected as data integrity condition are temporary in nature or are caused by a firmware error. Thus these should not require replacement of the device.

Currently, methods from restoring full mirroring redundancy require manual intervention and replacement of the failed device hardware. However, when a failure has exposed a RAID array, it is often the case that the device which failed could continue to operate.

### SUMMARY

Embodiments include a method, system, and computer program product for error recovery in storage systems that utilize data redundancy. The method includes monitoring plurality of storage devices of the storage system and determining that one of the plurality of storage devices has failed based on the monitoring. Another aspect of includes suspending data reads and writes to the failed storage device and determining that the failed storage device is recoverable. Based on determining that the failed storage device is recoverable, initiating a rebuilding recovery process of the failed storage device based on determining that the failed storage device is recoverable and restoring data reads and writes to the failed storage device upon completion of the rebuilding recovery process.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 illustrates a block diagram of a system in accordance with an exemplary embodiment;

FIGS. 2A-D depict block diagrams of a redundant storage system during the steps of an error recovery process in accordance with an exemplary embodiment;

FIG. 3 depicts a process flow for error recovery in a redundant storage system in accordance with an exemplary embodiment; and

FIG. 4 illustrates a computer program product in accordance with an embodiment.

### DETAILED DESCRIPTION

In exemplary embodiments, storage systems having redundant storage devices that may experience failures include methods and systems for recovering from such failures without physically replacing the failed devices. In exemplary embodiments, once a storage device, such as a hard disk drive (HDD) or solid state drive (SSD), has failed a determination of the type of failure is made. Based on the type of failure, a determination that the storage device can be returned to service is made and the storage device is rebuilt and returned to service without replacement of the storage device.

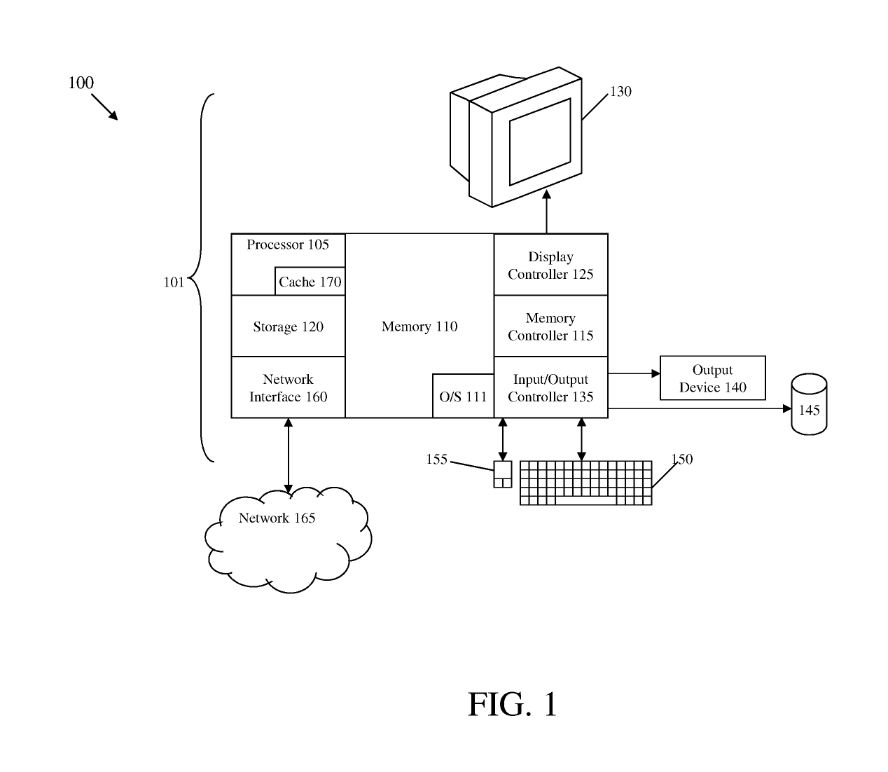

FIG. 1 illustrates a block diagram of an exemplary computer system 100 for use with the teachings herein. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a storage device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 includes a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110, includes a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

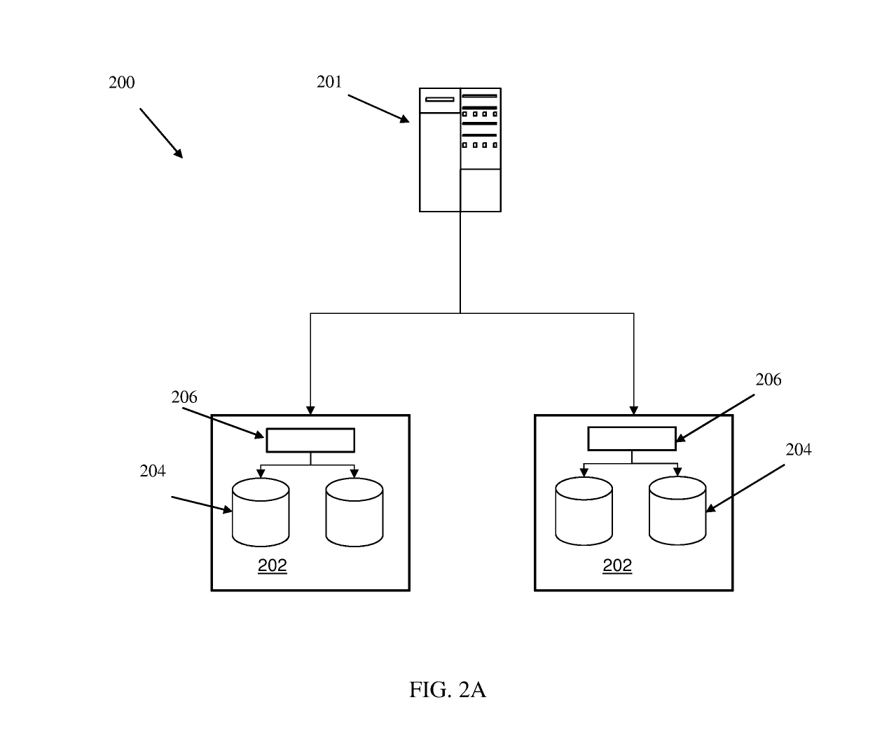

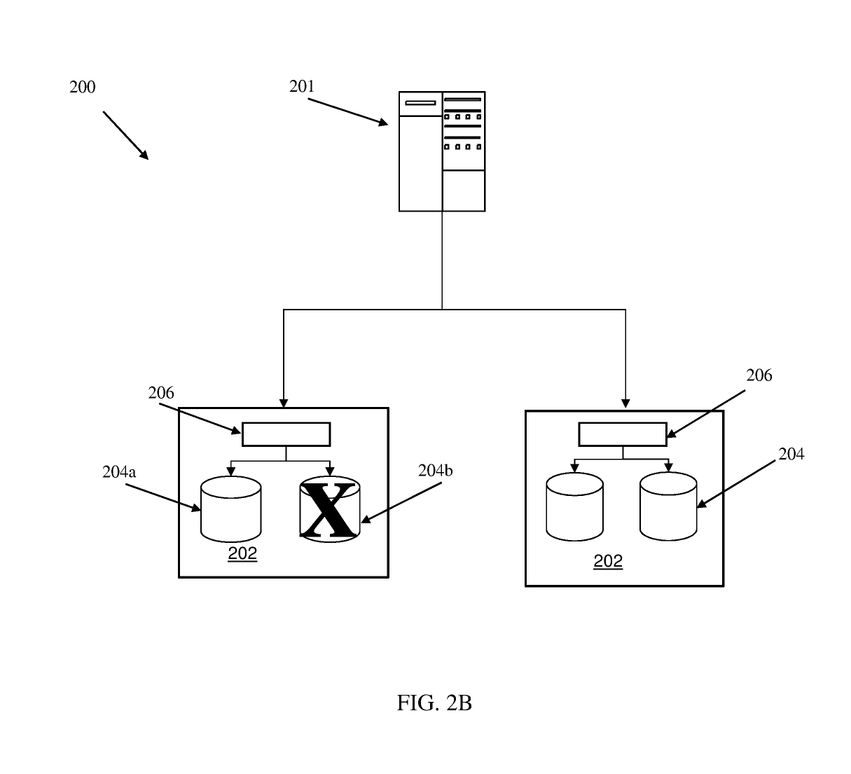

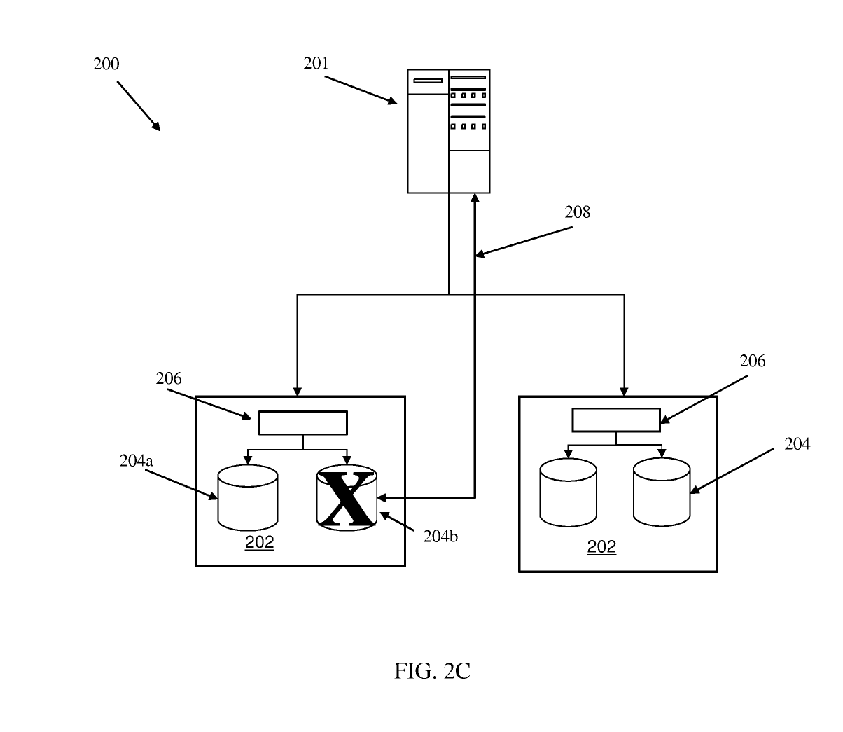

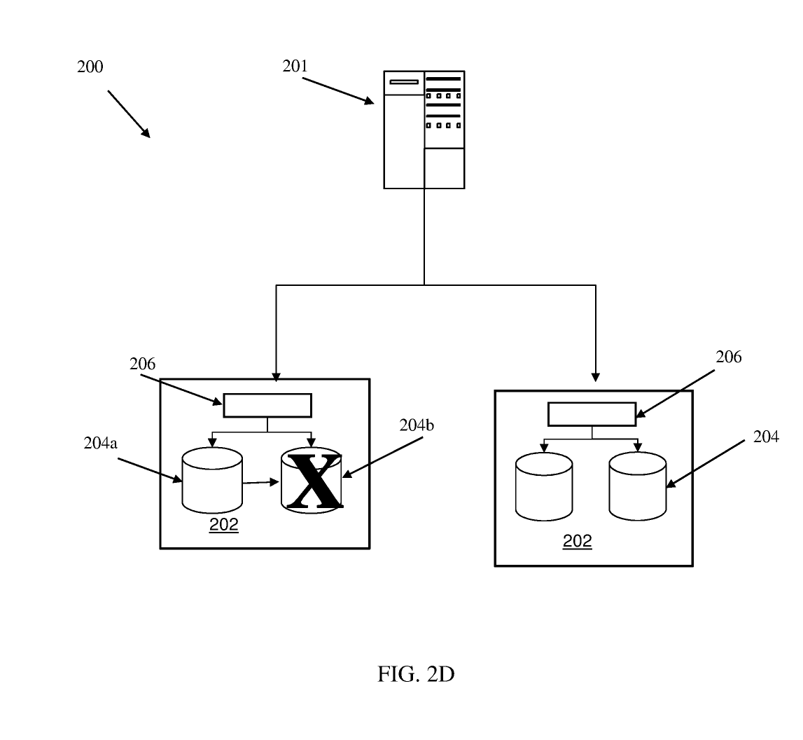

Referring now to FIG. 2A, a block diagram of a storage system utilizing data redundancy 200 operable for performing an error recovery process in accordance with an exemplary embodiment is shown. The storage system utilizing data redundancy 200 includes a host 201 that may be coupled to one or more storage systems 202. The storage systems 202 each include at least two storage devices 204 and a controller 206. In exemplary embodiments, the storage devices 204 may be any type of storage device including, but not limited to, a hard drive, a solid state storage device, or the like. In exemplary embodiments, the controller 206 of the storage system 202 controls the operation of the storage devices 204. During normal operation of the storage systems 202, the storage devices 204 are configured to each include identical copies of data. As illustrated, the host 201 may include one or more storage systems 202, which may be operated independently or in a mirrored configuration.

Referring now to FIG. 2B, a block diagram of a storage system utilizing data redundancy 200 operable for performing an error recovery process in accordance with an exemplary embodiment is shown. As illustrated, one of the storage devices 204b has failed. The failure of the storage device 204b has exposed the storage system 202. The term ‘exposed’ refers to exposing the storage systems 202 to the risk of an outage if the operational storage device 204a experiences an error when the storage system 202 is in this state. Once a determination that a storage device 204 has failed is made, the controller 206 suspends data reading and writing from the failed storage device 204b. Given the independence of the two storage devices 204, the probability of failure in the operational storage device 204a in a period following a failure of the storage device 204b is small. While this probability is small, it is not zero, so replacement or repair of the failed storage device 204b is required to restore the redundant and fault tolerant operation of the storage system 202.

Depending upon the cause of the failure, the failed storage device 204b may be capable of continued operation. For example, a failure may occur if the firmware in the storage devices 204 is unusually slow because of work it is focusing on at that moment as part of managing the data and metadata on the drives. In another example, a failure may occur because of a bug in the complex firmware of the storage devices 204 or the controller 206 that leads to a temporary inability to meet system requirements. Since the storage system 202 is designed to safeguard the stored data in all events, and since firmware in the drives, expanders, bridge and controller are extremely complex entities operating asynchronously, bugs in firmware will tend to expose storage systems 202 when there is the least doubt of the integrity of the stored data. As system demands continue to increase, these types of recoverable errors are becoming increasingly common.

Referring now to FIG. 2C, a block diagram of a storage system utilizing data redundancy 200 operable for performing an error recovery process in accordance with an exemplary embodiment is shown. As illustrated, one of the storage devices 204b has failed, exposing the storage system 202. Once the host 201, receives an indication that one of the storage devices 204b of the storage system 202 has failed, the host 201 communicates with the controller 206 of the storage system 202 and with the failed storage device 204b to determine the cause of the failure. Based upon the determined cause of the failure, the host 201 determines if the failed storage device 204b is capable of continuing to operate. In exemplary embodiments, the host 201 may communicate with the failed storage device 204b to obtain an error log and any additional debug data from the failed storage device 204b. In exemplary embodiments, the controller 206 may use standard small computer system interface (SCSI) commands in conjunction with vender-unique SCSI commands to determine the cause of the failure of the failed storage device 204b. In exemplary embodiments, the host 201 may be able to communicate with the failed storage device 204b directly through a SCSI pipe 208 which is configured to not adversely affect the ongoing operations of the storage system 202.

Referring now to FIG. 2D, a block diagram of a storage system utilizing data redundancy 200 operable for performing an error recovery process in accordance with an exemplary embodiment is shown. As illustrated, one of the storage devices 204b has failed, exposing the storage system 202. Once the host 201 determines that the failed storage device 204b is capable of continuing to operate, the host 201 initiates a rebuilding recovery process of the failed storage device 204b. In exemplary embodiments, the controller 206 may use standard (SCSI) commands in conjunction with vender-unique SCSI commands to initiate a rebuild recovery process to return the failed storage device 204b to normal active service. The rebuilding recovery process may include unlocking, resetting and reinitializes the failed storage device 204b. In addition, the rebuilding recovery process includes copying the data from the operational storage device 204a to the failed storage device 204b. As the copy from the operational storage device 204a to the failed storage device 204b progresses through the entire address space, the controller 206 transitions the failed storage device 204b online and reinstates full mirrored operation. In exemplary embodiments, the entire error recovery process executes in the background as host 201 requests for access to storage system 202 continues uninterrupted. In exemplary embodiments, the host 201 may be configured to only initiate the rebuilding recovery process upon determination that probability that the failed storage device 204b can be restored to normal operation exceeds a predetermined minimum threshold value.

In current common embodiments of RAID systems, when particular failures occur, the storage device 204 can enter a state referred to as ‘Secure Locked State’ which prevents further operation of the storage device 204, response to host 201 requests or access to any of the data held on the storage device 204. The Secure Locked State is designed to insure that large amounts of debug data are captured for analysis to enable effective debugging and failure cause determination. The Secure Locked State is also designed to insure that the system is not exposed to corrupted data. While the secure locked state is critical to maintaining system integrity, it has the negative consequence that it exposes the arrays to the risk of potential service outage if a second failure occurs, and it requires replacement of the device to re- establish fully redundant operation. This disclosure addresses these negative consequences by providing a method to rebuild the arrays when the nature of the failure is known to have only temporary consequences. A storage device 204 may enter the Secure Locked State as a result of hardware failures or as a result of firmware bugs. Since the risk to the data integrity of the storage system utilizing data redundancy 200 is the same regardless of the cause of the failure, the reaction of the storage device is the same. When a storage device 204 enters the Secure Locked State it exposes the storage system 202 that is a part of, and the failed storage device 204b needs to be replaced or repaired. In exemplary embodiments, the methods and systems described herein are capable of being used to recover and rebuild a storage device that has entered the Secure Locked State.

When the rebuilding recovery process is successfully completed, the storage system is returned to normal fully mirrored operation without replacement of the failed storage device, or the package that contains it. Because the rebuilding recovery process can occur without human involvement, it occurs much faster than would be possible if the failed storage device had to be scheduled for replacement. Accordingly, the time that the storage systems are subject to a second independent failure on the operational storage device is minimized. Furthermore, the cost of part replacement is minimized, including the cost of the failed storage device itself and the cost of the time of a skilled service team. The risk of system failure when the machine is being concurrently serviced by human technicians is minimized by the rebuilding recovery process, because human service technicians do not touch the system when the automatic recovery has been successful.

In current embodiments of RAID systems, the redundant storage system's performance is degraded when a storage system is exposed and parts are awaiting replacement, because storage devices which could service parallel fetches are offline when the storage system are in the exposed state. This causes all requests for fetch data to come from a single storage device. The rebuilding recovery process enables improved performance by returning the failing device to service as soon as possible. Additionally, the rebuilding recovery process mitigates the risk of unforeseen firmware bugs that can cause exposures of storage systems. These bugs are rendered much less threatening because they are much less likely to cause outages or high service costs. Another benefit of the rebuilding recovery process is that the long recovery times of storage devices no longer threaten system outages when timeouts occur during recovery. Finally, the rebuilding recovery process makes use of log data to enable the host to decide to bring the failed storage device back online or leave it offline based on the risk of detrimental effects on the stored data. This capability allows the optimization of data integrity simultaneous to the optimization of system availability.

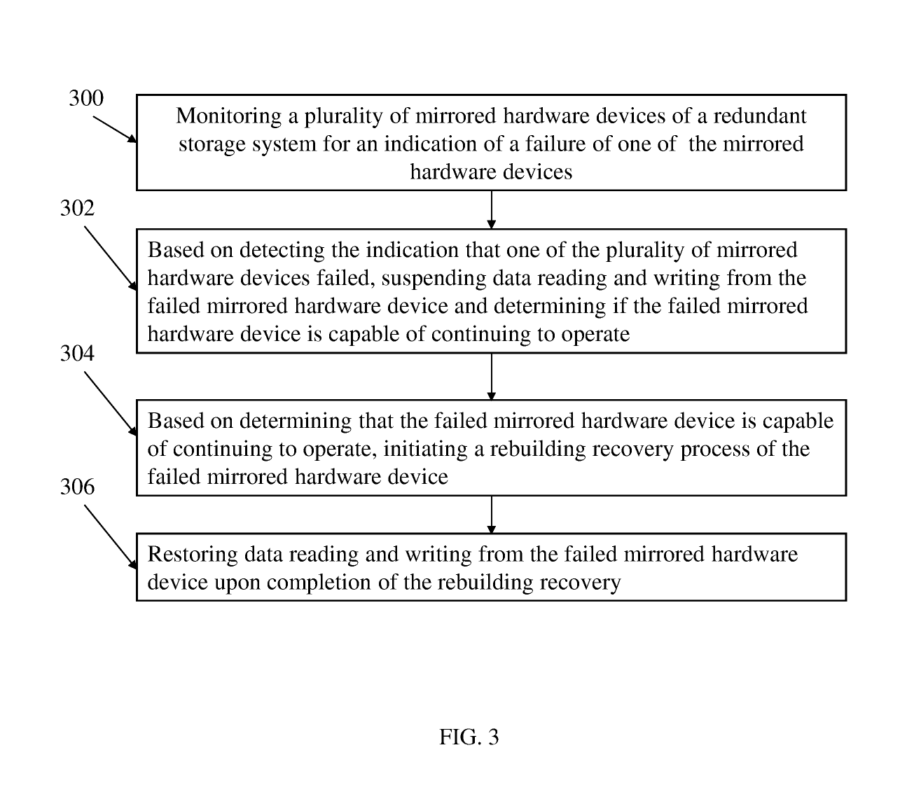

Referring now to FIG. 3, a process flow for error recovery in a storage system utilizing data redundancy in accordance with an exemplary embodiment is shown. As illustrated, the process includes monitoring a plurality of storage devices of the storage system utilizing data redundancy for an indication of a failure of one of the plurality of storage devices, as shown at block 300. Next, as shown at block 302, the process includes suspending data reading and writing from the failed storage device and determining if the failed storage device is capable of continuing to operate, based on detecting the indication that one of the plurality of storage devices failed. Based on determining that the failed storage device is capable of continuing to operate, the process includes initiating a rebuilding recovery process of the failed storage device, as shown at block 304. Next, as shown at block 306, the method includes restoring data reading and writing from the failed storage device upon completion of the rebuilding recovery.

As will be appreciated by those of ordinary skill in the art, the methods and systems described herein for recovering and rebuilding failed storage devices may be used in conjunction with a variety of storage protocols. For example, the methods and systems disclosed herein can be applied to a storage system using RAID-0, RAID-1, RAID-5 and RAID-6 or any combination thereof which is configured provide data redundancy.

As will be appreciated by one skilled in the art, one or more aspects of the present invention may be embodied as a system, method or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

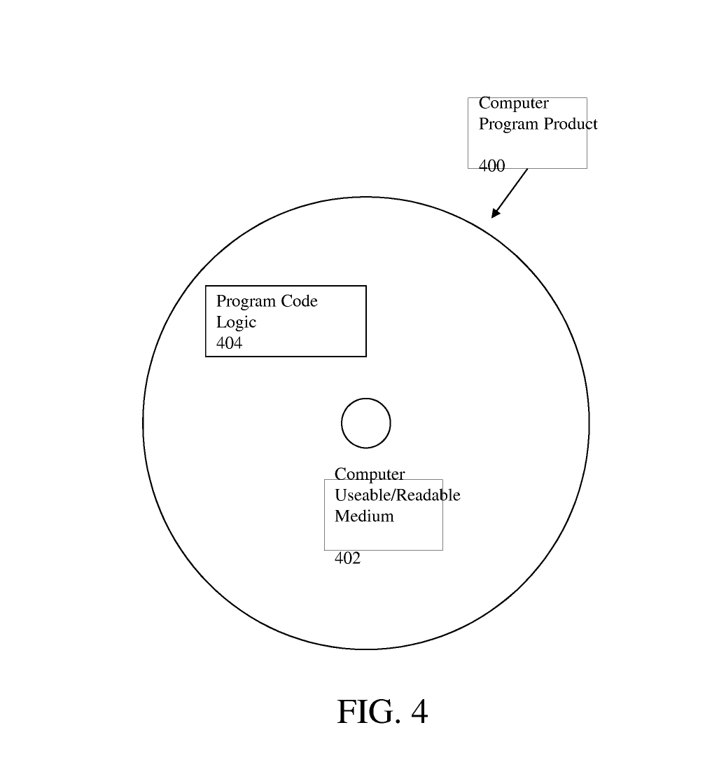

Referring now to FIG. 4, in one example, a computer program product 400 includes, for instance, one or more storage media 402, wherein the media may be tangible and/or non-transitory, to store computer readable program code means or logic 404 thereon to provide and facilitate one or more aspects of embodiments described herein.

Embodiments include a method, system, and computer program product for error recovery in a storage system that utilizes data redundancy. The method includes monitoring plurality of storage devices of the storage system and determining that one of the plurality of storage devices has failed based on the monitoring. Another aspect of includes suspending data reads and writes to the failed storage device and determining that the failed storage device is recoverable. Based on determining that the failed storage device is recoverable, initiating a rebuilding recovery process of the failed storage device based on determining that the failed storage device is recoverable and restoring data reads and writes to the failed storage device upon completion of the rebuilding recovery process.

In an embodiment, determining that the failed storage device is recoverable includes using one or more commands to communicate with the failed storage device.

In an embodiment, the one or more commands include one or more standard small computer system interface (SCSI) commands and one or more vendor-unique commands.

In an embodiment, the rebuilding recovery process of the failed storage device includes clearing prior error conditions and re-initializing the failed storage device.

In an embodiment, the rebuilding recovery process of the failed storage device further includes copying data from an operational storage device to the failed storage device.

In an embodiment, copying data from the operational storage device to the failed storage device occurs as a background process and does not substantially affect performance of the operational storage device.

In an embodiment, the method further includes based on a detection of an error condition during the rebuilding recovery process of the failed storage device, terminating the rebuilding recovery process.

Technical effects and benefits include method and systems for identifying recoverable errors in storage devices that allow storage devices to be rebuilt and reused without requiring physical replacement of the storage device.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application, and to enable others of ordinary skill in the art to understand the embodiments with various modifications as are suited to the particular use contemplated.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described above with reference to flowchart illustrations and/or schematic diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer system for providing error recovery in a storage system that utilizes data redundancy, the system comprising:
a host coupled to one or more storage systems, wherein each storage system includes a controller and a plurality of storage devices, the system configured to perform a method comprising:
monitoring the plurality of storage devices of the storage system;
determining that one of the plurality of storage devices has failed based on the monitoring:
suspending data reads and writes to the failed storage device;
determining that the failed storage device is recoverable;
initiating a rebuilding recovery process of the failed storage device based on determining that the failed storage device is recoverable; and
restoring data reads and writes to the failed storage device upon completion of the rebuilding recovery process.

2. The computer system of claim 1, wherein determining the failed storage device is recoverable comprises using one or more commands to communicate with the failed storage device.

3. The computer system of claim 2, wherein the one or more commands include one or more standard small computer system interface (SCSI) commands and one or more vendor-unique commands.

4. The computer system of claim 1, wherein the rebuilding recovery process of the failed storage device includes clearing prior error conditions and re-initializing the failed storage device.

5. The computer system of claim 4, wherein the rebuilding recovery process of the failed storage device further includes copying data from an operational storage device to the failed storage device.

6. The computer system of claim 5, wherein copying data from the operational storage device to the failed storage device occurs as a background process and does not substantially affect performance of the operational storage device.

7. The computer system of claim 1, further comprising:
based on a detection of an error condition during the rebuilding recovery process of the failed storage device, terminating the rebuilding recovery process.

8. A computer implemented method for error recovery in a storage system that utilizes data redundancy, the method comprising:
monitoring plurality of storage devices of the storage system;
determining that one of the plurality of storage devices has failed based on the monitoring:
suspending data reads and writes to the failed storage device;
determining that the failed storage device is recoverable;
initiating a rebuilding recovery process of the failed storage device based on determining that the failed storage device is recoverable; and
restoring data reads and writes to the failed storage device upon completion of the rebuilding recovery process.

9. The computer implemented method of claim 8, wherein determining the failed storage device is recoverable comprises using one or more commands to communicate with the failed storage device.

10. The computer implemented method of claim 9, wherein the one or more commands include one or more standard small computer system interface (SCSI) commands and one or more vendor-unique commands.

11. The computer implemented method of claim 8, wherein the rebuilding recovery process of the failed storage device includes clearing prior error conditions and re-initializing the failed storage device.

12. The computer implemented method of claim 11, wherein the rebuilding recovery process of the failed storage device further includes copying data from an operational storage device to the failed storage device.

13. The computer implemented method of claim 12, wherein copying data from the operational storage device to the failed storage device occurs as a background process and does not substantially affect performance of the operational storage device.

14. The computer implemented method of claim 8, further comprising:
based on a detection of an error condition during the rebuilding recovery process of the failed storage device, terminating the rebuilding recovery process.

15. A computer program product for providing error recovery in a storage system utilizing data redundancy, the computer program product comprising:
a tangible storage medium readable by a processing circuit and storing instructions for execution by the processing circuit for performing a method comprising:
monitoring plurality of storage devices of the storage system;
determining that one of the plurality of storage devices has failed based on the monitoring:
suspending data reads and writes to the failed storage device;
determining that the failed storage device is recoverable;
initiating a rebuilding recovery process of the failed storage device based on determining that the failed storage device is recoverable; and
restoring data reads and writes to the failed storage device upon completion of the rebuilding recovery process.

16. The computer program product of claim 16, wherein determining the failed storage device is recoverable comprises using one or more commands to communicate with the failed storage device.

17. The computer program product of claim 16, wherein the one or more commands include one or more standard small computer system interface (SCSI) commands and one or more vendor-unique commands.

18. The computer program product of claim 15, wherein the rebuilding recovery process of the failed storage device includes clearing prior error conditions and re-initializing the failed storage device.

19. The computer program product of claim 18, wherein the rebuilding recovery process of the failed storage device further includes copying data from an operational storage device to the failed storage device.

20. The computer program product of claim 19, wherein copying data from the operational storage device to the failed storage device occurs as a background process and does not substantially affect performance of the operational storage device.
